(19) United States
(12) Patent Application Publication
(10) Pub. No.: US 2016/0123514 A1
(43) Pub. Date: May 5, 2016

(54) METHOD AND APPARATUS FOR INSTALLTION AND REPAIR OF PIPE SYSTEMS

(71) Applicant: TSC INNOVATION AB, Umeå (SE)

(72) Inventor: Lars Gunnarsson, Strängnäs (SE)

(73) Assignee: TSC Innovation AB, Umea (SE)

(21) Appl. No.: 14/889,744

(22) PCT Filed: May 8, 2013
(86) PCT No.: PCT/SE2013/050524

§ 371 Date: Nov. 6, 2015

(51) Int. Cl. F16L 47/03; F16L 21/00

(52) U.S. Cl. CPC F16L 47/03; F16L 21/00

(57) ABSTRACT

A method for joining or repairing a pipe system that comprises a least two pipes made of weldable plastic material, comprising: fitting a sleeve made of weldable plastic material the distance between the two pipes, the sleeve having a length A that exceeds the distance B between the mutually opposing pipes, such as to overlap each pipe end to a given extent C; placing an electrically conductive band around one of the pipes, the band having two ends; connecting the band ends to each other by placing the band ends overlapping each other; fitting the sleeve over and against the pipe and the band, and applying an electric current to the band over a given period of time, thereby heating the band to a determined temperature for a determined time and fusing the band with the plastic surfaces of the pipe and the sleeve lying in abutment therewith to form a welding joint being fully executed around the pipe and inside the sleeve.

### TECHNICAL FIELD

The present invention relates to a method and apparatus for installation and repair of pipe systems comprising at least two pipes made of a weldable plastic material according to the preamble of independent claims 1 and 19.

### BACKGROUND

Pipe systems are used in many different transporting situations and for transport of different kinds of gases, liquids, fluids, mediums, materia or substanses inside the pipes. The need for functioning attachments of the pipes to each other is wery important, both to secure the transportation inside the pipe system from leaking out, but also from contamination or other damage from outside.

Some pipe systems are intended to be concealed underground, which entails large stresses. There will be a mechanical impact on the pipes owing to temperature changes, which result in expansion and contraction of the material. The pipe systems is also exposed to water or moisture that can penetrate it and cause the steel pipe to corrode, which over time can result in leaking and consequently require repairs. The pipe systems often runs under walls and the like, making it difficult and costly, in the event of leaking, to gain access to the damaged pipe systems that has to be dug out.

Even if the pipe system is placed on or above the ground the need for functioning attachments of the pipes to each other is wery important. A leak can be located with relatively high accuracy but the cost of repairs of all kinds of pipe systems will be high. Consequently, it is of greatest importance to produce installations, joints of high quality and strength, both in new installation and when making repairs. Inconsistent quality, or, in the worst case, systematic defects in assembly, can in the long run be devastating to the overall economics of the pipe system.

There are presently on the market a number of methods of joining pipes. Experience has shown that methods that employ welded joints often have advantages over the long term, compared to other solutions. However, welding is not totally without problems.

One method is used for pipes made of a weldable polymer material and comprises the use of a welding band, electrically conductive band. Two pipes are to be connected to each other. One welding band is placed around each pipe end and covered by a sleeve made of weldable polymer material reaching over the distance between the two pipe ends, having an overlap on each pipe end. The sleeve is heated and is then shrinked on each pipe end. The band is connected to an electric device and by using resisting heating the band is heated. The band is heated and is then melting both the plastic of the pipe and the plastic of the sleeve. The plastics will then mix. When the electric device is disconnected or shut down the melted mixed plastics will cool down and join the sleeve to each the pipe as a weld is made.

The electric device is connected to the two ends of the band. The ends, or electrodes connected to the band, are bent and placed outside the pipe, projecting out through a slot in the sleeve, and the area where the band ends, or the electrodes, are to be put together is not really that precise. There is a space between the band ends, the elctrodes, in the area of the pipe and sleeve. This is a critical point of the weld as there is no completed and controlled melting of the plastics in the area where the electric connections to the band ends is made. The band ends are drawn apart a bit and the plastics are not realy heat treaded in this area. This will result in a weak point of the weld where leak can occure.

### SUMMARY OF THE INVENTION

One object of the present invention is to provide a method and an apparatus that in a simple, safe and effective way enables a reliable leek-proof welding when installing and repairing pipe systems 1 so that a good joint, weld, is formed.

This object is achieved with the method having the distinctive technical features presented in the characterizing portions of claim 1 and the apparatus having the distinctive technical features presented in the characterizing portions of claim 19.

Exemplifying embodiments can be found in the dependent claims.

Additional distinctive features and advantages of the invention will be presented in the following detailed description of the invention, which shall constitute an example, and thus shall not be interpreted in a manner that they limit the invention's scope of protection. To facilitate understanding, to the text have been added references to the attached drawings, in which equivalent or similar components have been provided the same or similar reference designation.

### BRIEF DESCRIPTION OF THE DRAWINGS

FIG. 1 shows an apparatus according to the present invention placed in working position, to be able to work according to the method according to the present invention.

FIG. 2 shows two outer pipes to be joined or repaired by both the method and the apparatus according to the present invention.

FIG. 3 shows a detailed section of the area between a pipe and a sleeve to be connected according to both the method and the apparatus according to the present invention.

FIG. 4 shows a power converter to be used both in the method and the apparatus according to the present invention.

FIGS. 5 and 6 show a construction comprising two power converters to be used both in the method and the apparatus according to the present invention.

FIGS. 7, 8 and 9 show three devices A1-A3, welding equipments, arranged at a weld area made for working according to both the method and the apparatus according to the present invention.

FIG. 10 shows an indicator unit to be used both in the method and the apparatus according to the present invention.

### DETAILED DESCRIPTION OF THE INVENTION

### Method

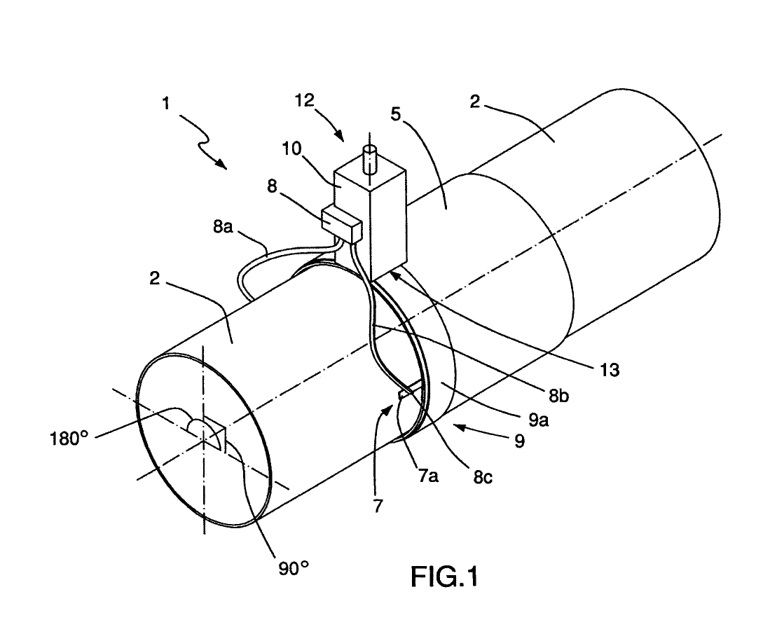

This invention concerns a method for joining a pipe system 1. The pipe system 1 comprises at least two pipes 2 that are to be connected to each other. The pipes 2 are made of weldable plastic, polymeric, material. See FIG. 1.

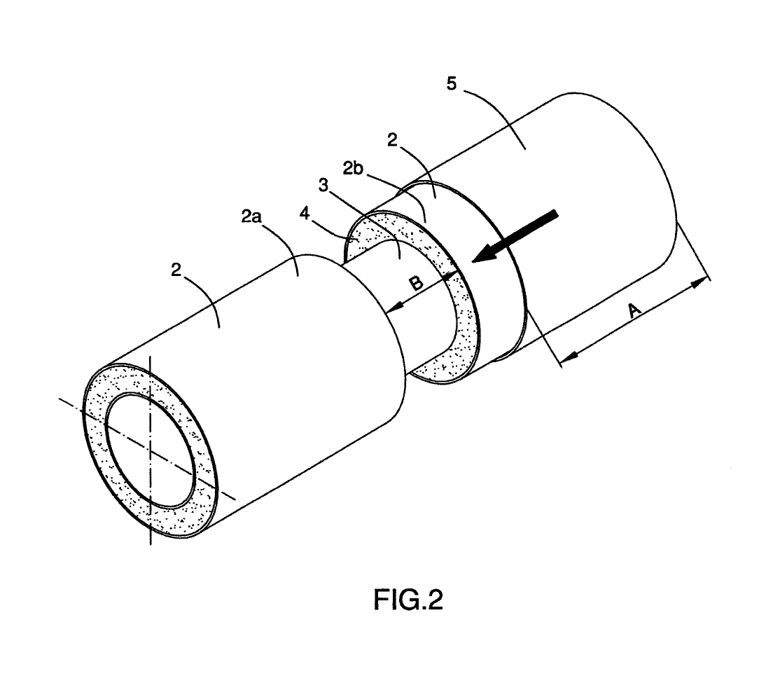

The pipe systems 1 can be made for transporting different kinds of gases, liquids, fluids, mediums, materia or substances, being pressurized or not. The pipe systems 1 can have different designs, the pipes 2 can have different constructions. The pipes 2 can comprise inner pipes 3 placed inside the pipes 2, then being outer pipes 2. The space between the outer pipe 2 and the inner pipe 3 can be filled with an insulation material 4. See FIG. 2. In the following description the wording “pipe 2” means the pipe that is to be welded with a sleeve and is the “outer pipe 2” if the pipe system is insulated.

Insulated pipe systems are ordinarily used for transporting a flowing heating or cooling fluid, the medium, as in district-heating or district-cooling pipe systems, and have a steel pipe for transporting the flowing fluid, the medium. The steel pipe is then embedded in insulation, usually made of polyurethane (PUR) foam, and on the outside there is an outer casing that protects from moisture, an outer pipe, made of a weldable plastic material, commonly of polyethylene. The pipe systems are fabricated in a factory in sections, with an outer pipe 2, an inner pipe 3, and insulation 4, which are then transported out to the installation site. Insulated pipe systems of this type can also be used for the transporting of for example oil, LNG and chemicals.

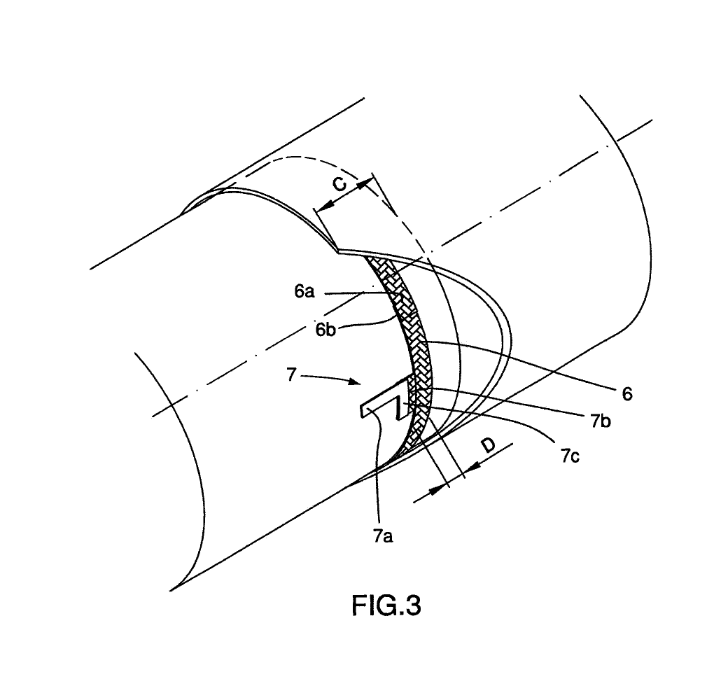

The method comprises the step of fitting a sleeve 5 made of weldable plastic, polymeric, material the distance between the two pipes 2, the sleeve 5 having an overlap on each pipe end 2a and 2b. See FIGS. 1 and 2. The sleeve 5 will be attached the two pipes 2 and after welding the sleeve 5 will be a part of the pipe 2, the pipe system 1. The sleeve 5 has a length A that exceeds the distance B between the mutually opposing pipe-ends 2a and 2b such as to have an overlap the pipe ends 2a and 2b to a given extent C. See FIG. 3. The sleeve 5 is made in one piece and is a larger in diameter than the outer pipe 2.

The method also comprises the steps of placing an electrically conductive band 6 around the end of one of the pipes 2, an electrically conductive band 6 which is permeable to molten plastic, connecting the ends 6a and 6b of the band 6 to each other by placing the ends 6a and 6b overlapping each other, fitting the sleeve 5 over and against the pipe 2 the pipe end 2a or 2b, and the band 6, overlapping the pipe 2, the pipe end 2a or 2b, and covering the band 6. See FIG. 3.

There is also comprised in the method applying an electric current to the band 6 over a given period of time and thereby heating the band 6 to a determined temperature for a determined time and fusing the band 6 with the plastic surfaces of the pipe 2 and the sleeve 5 lying in abutment therewith to form a welding joint having a width D corresponding to the width of the band 6 and being fully executed around the pipe 2 and inside the sleeve 5. The band 6, and the weld, has a width smaller than, or similar to, the sleeve overlap C. See FIG. 1-3.

As the band ends 6a and 6b are placed overlapping each other the plastics of both the pipe 2 and the sleeve 5 will be heated all around the pipe 2 and sleeve 5 and the weld will be fully working all around, even in the band overlapping area. The method enables a reliable leek-proof welding when installing and repairing pipe systems 1 so that a good joint is formed in a simple, safe and effective way.

The former way to weld pipes 2 by using a band and to apply electric current specifically to the ends of the band, the ends projecting out through a slot in the sleeve, can cause uneven heating of the plastic areas and cause burning-through. The current distribution in the band can wary due to the long distance for the current to be transported in the band and thereby effect the temperature of the band in different ways in different areas. This will result in a weld having negative properties. To avoid this malfunction the invented method comprises placing the electrically conductive band 6 around the end of one outer pipe 2 and connecting at least two conductors 7 to the band 6 making it possible to attach the band 6 to an electrial device 8 applying the electric current to the band 6. See FIG. 1. The electric current will then be distributed from at least two places on and to the band 6 and the transport distances will be less long, resulting in better heating of the band 6 and the plastics of the pipe 2 and the sleeve 5.

The method comprises connecting at least two conductors 7 to the band 6, connecting at least two metal sheets 7a to the band 6. The connection can be done by attaching each conductor 7, each sheet 7a, to the band 6 by placing an extra band 7b between the band 6 and the sheet 7. Connecting an insulating device 7c between the band 6 and each the metal sheet 7a can also be done. Using the metal sheets 7a will make it possible to connect the electric current in an easy and well known electric directing way, using the extra band 7b makes sure that the weld will be done in a controlled manner an in an extra area, resulting in a weld point that is enhanced, and using the insulating device 7c vill provide a possibility to control the placement of the weld. See FIG. 3.

The connecting of at least two conductors 7 to the band 6 comprises placing the conductors 7 at fixed decided places around the band 6 for even distribution of the electric current around the band 6 and the heat around the pipe 2 and sleeve 5. When using two conductors 7 the method comprises placing the conductors 7 at about 180° displacement in relation to each other along the band 6 and placing the conductors 7 at about 90° displacement in relation to the electrial device 8, along the band 6. The description ofh the placing being “about” means that for different situations the placing can be both closer together and more far way. The importantcy of the placing is that not all the devices involved in the electric current disitribution is placed at one spot, in one area. See FIG. 1. This placing will result in a good distribution of the electric current along the band 6.

Work regarding joining or repairing pipes 1 is often done outside, having different weather circumstances. The pipe 2 can for exemple have a higher temperature on the top side due to sun shine than on the bottom side being placed away from the sun. When applying an electric current to the band 6 having two current inlets, using the conductors 7, placed more or less horisontally at 180° displacement in relation to each other gives the result that the effect needed to heat the plastics of the pipe 2 and the sleeve 5 in the area of the top side and bottom side having different temperatures will be selfregulated due to the different resistances in the areas having different temperatures. In the top area of the pipe 2, heated by the sun, the resistance in the band 6 is higher than on the bottom side and the current will choose the bottom side having lower resistance, more current will pass the way in the band 6 on the bottom side of the pipe. The current will by that work in the area that will need it due to the resistance difference, and the heating will be the same all around the pipe 2.

The fitting of the sleeve 5 over, around and against the end 2a or 2b of the pipe 2 comprises heating the sleeve 5 being a shrink sleeve 5, made of shrinkable material controlled by adding heat, and thereby reducing the diameter of the sleeve 5 so that the inside of the sleeve 5 comes into contact with the outside of the pipe 2. The band 6 will then be fixed in place between the pipe 2 and the sleeve 5.

The fitting of the sleeve 5 over, around and against the end of the pipe 2 comprises attaching a pressure force on to and around the sleeve 5 at the part of the sleeve 5 fitted over, around and against the end of the pipe 2a or 2b. The attaching of a pressure force on to and around the sleeve 5 is made possible by using a pressure tool 9 working on and around the sleeve 6. See FIG. 1. This will make sure that the band 6 will be fixed in place between the pipe 2 and the sleeve 5.

The using of a pressure tool 9 comprises using of a clamping strap 9a which is looped around the sleeve 5 and connecting the free ends of the clamping strap 9a to a tensioning device 10 which functions to tighten the strap 9a around the sleeve 5 and therewith press the sleeve 5 against the pipe 2. This is not shown in the figures.

The method may comprise drilling a hole through the sleeve 5 for the purpose of pressure testing the made weld. If the pipe system 1 comprises an outer pipe 2 and an inner pipe 3 this hole can be used for filling the joint with foam for making the isolation completed. A plug has to be placed in the hole such as to seal the hole. This is not shown in the figures.

The power supply can be a problem. There can easily be heavy power losses, because current transformation can be necessary and the current has to be conducted over relatively long distances to reach the welding site itself. The available power supplies are not always the best. Another object of the invention is therefor to enable a reliable supply of current for welding during the installation and repair of insulated pipe systems so that a good joint is formed.

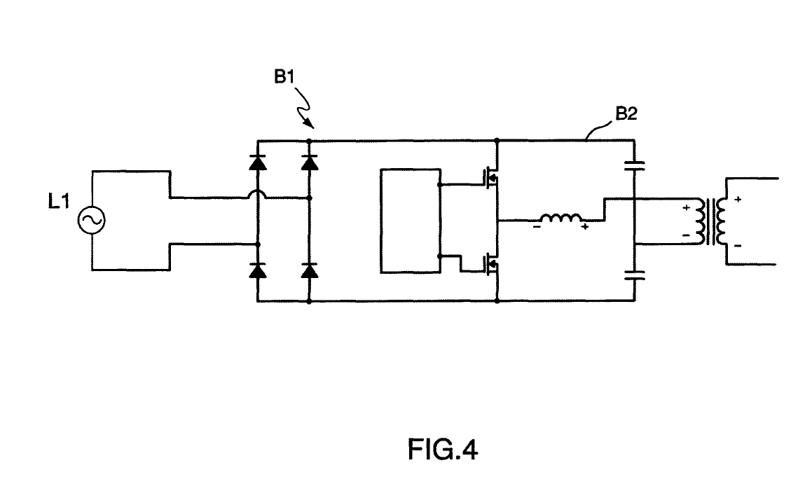

For this reason the method comprise for this the step of employing a power converter B1 which has a quasi-resonant converter B2 to produce the electric current that is to be connected to the band 6. See FIG. 4.

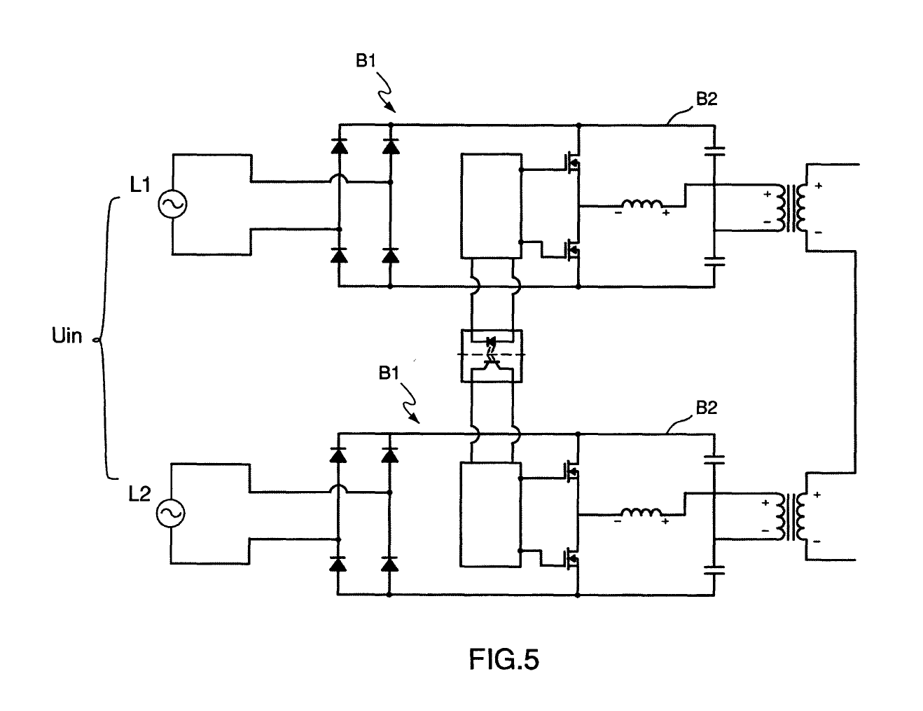

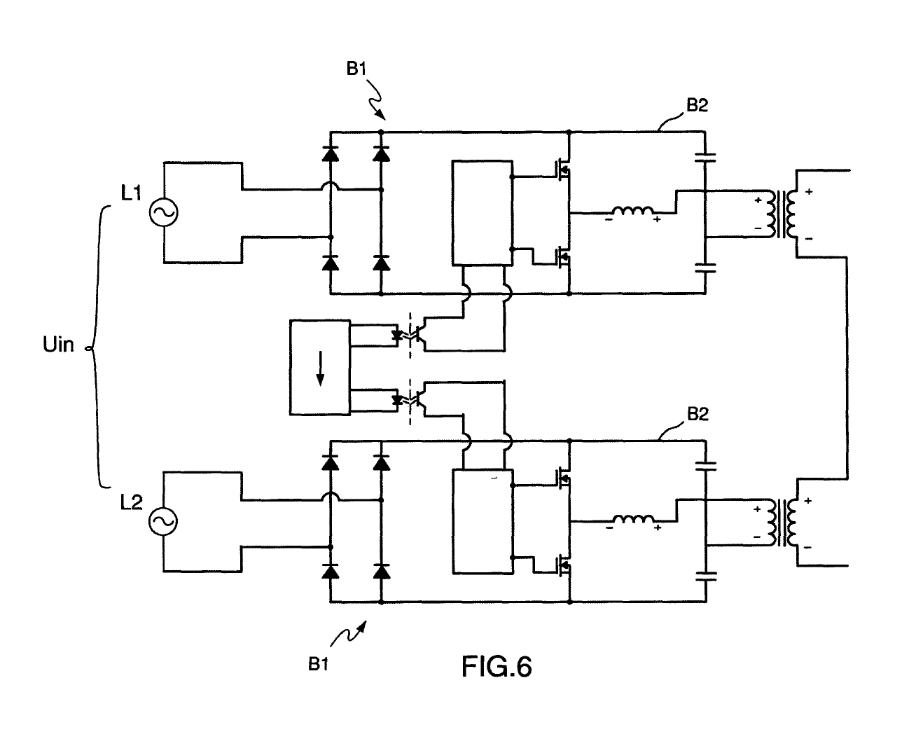

The method can also comprise the step of employing two series-connected power converters B1 that are connected to two different phase and summing the output voltage via the synchronous operation of two quasi-resonant converters B2 in order to produce the electric current that is to be connected to the band 6. See FIGS. 5 and 6.

Heat must be supplied during a sufficiently long period for the temperature in the area of the band 6, the weld area, to become sufficiently high for a mechanically strong and sealing weld of high quality to be formed. If insufficient heat is supplied, parts of the weld area will not reach the desired temperature and the expected melting will not occur, and this will result in the weld being of lower quality. In contrast to this, if too much heat is supplied it is the case that there is a risk that the material in the ends of the pipes and the sleeve will be damaged through deformation of the pipe. It is therefore important to control carefully the supply of heat such that sufficient heat is supplied during a certain period of time, such that a weld of high quality is formed between the ends of the pipe 2 and the sleeve 5.

Another object of the invention is therefore to offer a method that make possible in a simple, efficient and secure manner reliable temperature control and control of the heat supply to the band 6, to the weld area, such that a high-quality weld is formed. For this reason the method comprise;

measuring the initial ambient temperature T₀ of the band area before the band 6 is heated,

measuring a voltage U_{L} across the band 6,

measuring the electrical current I_{L} supplied to the band 6,

calculating the initial resistance R₀ of the band 6 before the band 6 is heated,

supplying the electrical current to the band 6 in an altering or constant way,

calculating continuously the resistance R of the band 6 based on the voltage and the measured current,

calculating the change ΔR in resistance and

calculating the increase ΔT in temperature of the band 6 based on the change in resistance and

calculating the temperature T_{W} of the weld through adding the initial ambient temperature T₀ of the weld and the increase ΔT in temperature of the band 6.

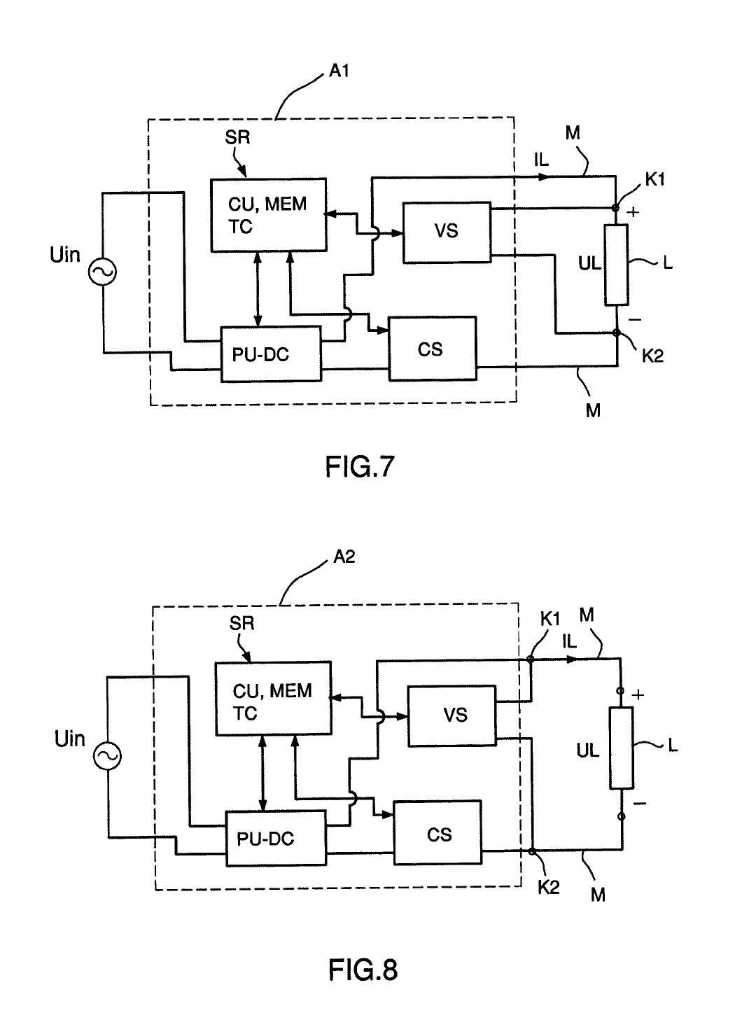

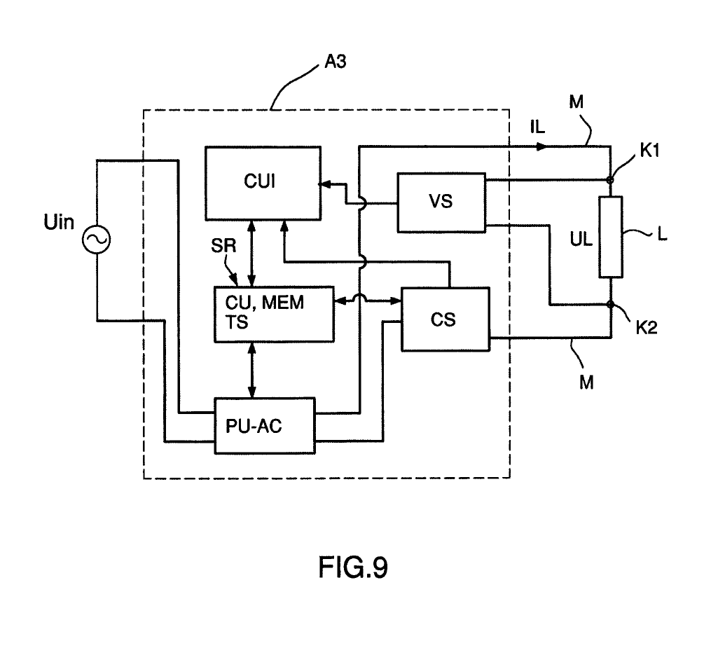

In FIGS. 7-9 tree embodiments of a device A1-A3, a welding equipment, arranged at a weld area, made for working according to this method, are shown.

Once the welding process has ended, the welded joint must cool before the electrical device 8, the welding equipment, and the pressure device 9, the clamping strap 9a and the tension device 10, can be removed, in order to avoid damage to the newly welded joint. The cooling period is a time-consuming part of the welding. In the context of production, it is important to achieve a high efficiency, and it is desirable to carry out the welding with a high weld quality and in a time-efficient manner.

Another object of the invention is therefore to offer a method that make possible efficient and reliable temperature monitoring of the cooling process in the welded joint once the welding process has ended. For this reason the method comprise;

a measurement process is carried out after the welding process has ended that comprises the supply of a current Ip to the band 6 from an indicator unit 11,

that a resulting temperature-dependent parameter Sp of the band 6 is determined by the indicator unit 11, the value of Sp is stored in the indicator unit 11,

that a further current pulse Ip is supplied to the band from the indicator unit 11 after a predetermined time interval, that the parameter Sp in the band is determined and that the value of Sp is stored in the indicator unit 11,

that the indicator unit 11 monitors and evaluates the value of the parameter Sp or the relative change in the value of the parameter Sp,

that the measurement process is repeated until Sp reaches a plateau value or the relative change of Sp reaches a predetermined level,

that a signal arrangement signals that the welding equipment can be removed from the area of the weld when the indicator unit 11 indicates that the cooling process has ended.

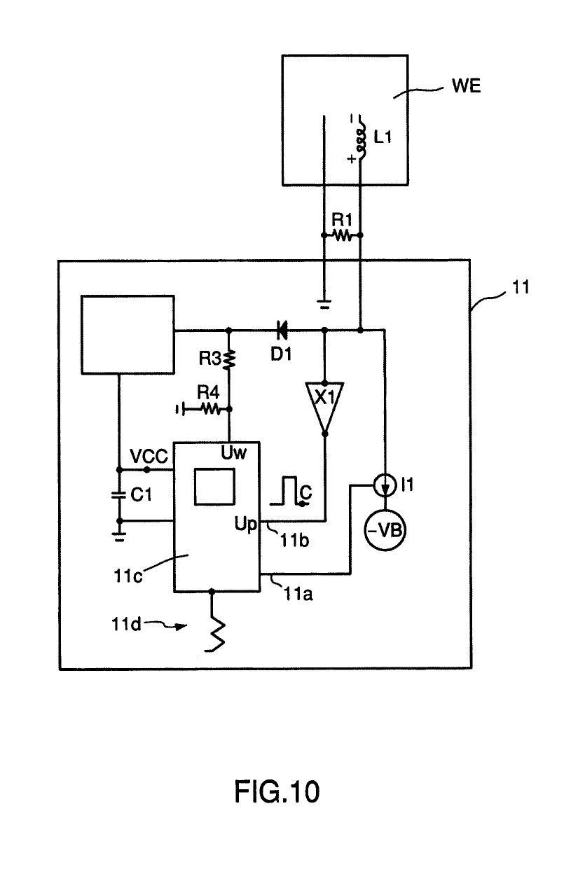

See FIG. 10.

### Apparatus

The present invention also concerns an apparatus 12 to be used when practicing, using, working according to the above described method. The apparatus 12 shall be used when fitting the sleeve 5 over and against one or both the end 2a or 2b of one or both the pipes 2 and the band 6, overlapping and covering the band 6 and when applying the electric current to the band 6, thereby heating the band 6 to a determined temperature for a determined time and fusing the band 6 with the plastic surfaces of the pipe 2 and the sleeve 5 lying in abutment therewith. This result in forming a welding joint and the joint, the weld, being fully executed around the pipe 2 and inside the sleeve 5. The band 6, and the weld, has a width smaller than, or similar to, the sleeve overlap C. The apparatus comprises the device 8, the electric device, applying an electric current to the band 6 and thereby heating the band 6 and melting the plastic of the pipe 2 and the sleeve 5, and the device 9, the pressure tool, attaching a pressure force on to and around the sleeve 5 at the part of the sleeve 5 fitted over, around and against the end of the pipe 2. See FIG. 1-3.

The electric device 8 comprises at least two electric cables 8a and 8b each having an attaching device 8c, preferable at the end of each cable 8a and 0b, to be connected to the band 6. Each attaching device 8c is designed to be in working condition with a conductor 7 connected to the band 6.

The pressure tool 9 comprises the clamping strap 9a which is looped around the sleeve 5 and the tensioning device 10 to which the two free ends of the clamping strap 9a are connected to and which functions to tighten the loop and therewith press the sleeve 5 against the pipe 2. The work of the clamping strap 9a and the tensioning device 10 will make sure that the band 6 will be fixed in place between the pipe 2 and the sleeve 5. The working of the tensioning device is not shown in detail in the figures.

The apparatus 12 comprises a support device 13 to help the apparatus 12 to be placed on the outside of the sleeve 5 when the pressure tool 9 is used, when the tensioning device 11 is attached to the clamping strap 9a. The support device 13 comprises guide rollers arranged in mutually parallel and mutually spaced relationship adjacent the support device, wherein the distance between the rollers is much smaller than the diameters of the pipe. The end parts of the clamping strap 9a are extending from the loop run between the guide rollers. The support device 13 comprises an abutment surface which is concave so as to provide good abutment with the outwardly curved pipe surface. At least the abutment surface is made of an electrically insulating material. This support device 13 is not shown in detail in the figures.

The power supply can be a problem. There can easily be heavy power losses, because current transformation can be necessary and the current has to be conducted over relatively long distances to reach the welding site itself. The available power supplies are not always the best. Another object of the invention is therefor to enable a reliable supply of current for welding during the installation and repair of insulated pipe systems 1 so that a good joint is formed.

For this reason the apparatus 12 comprises a power converter B1 which has a quasi-resonant converter B2 for producing the electric current that is to be connected to the band 6 for a determined period of time, to heat the band 6 and the surrounding polymer material of the pipe 2 and the sleeve 5 so that they fuse together around the band 6 in order to form a weld joint. See FIG. 4.

The apparatus can in another embodiment comprise two series-connected power converters B1 that are connected to two different phases and two quasi-resonant converters B2 that, via synchronous operation, sum the output voltage by performing a summation function to produce the electric current that is to be connected to the band 6 for a determined period of time, to heat the band 6 and the surrounding polymer material of the pipe 2 and the sleeve 5 so that they fuse together around the band 6 in order to form a weld joint. See FIGS. 5 and 6.

Heat must be supplied during a sufficiently long period for the temperature in the area of the band 6, the weld area, to become sufficiently high for a mechanically strong and sealing weld of high quality to be formed. If insufficient heat is supplied, parts of the weld area will not reach the desired temperature and the expected melting will not occur, and this will result in the weld being of lower quality. In contrast to this, if too much heat is supplied it is the case that there is a risk that the material in the ends of the pipes and the sleeve will be damaged through deformation of the pipe. It is therefore important to control carefully the supply of heat such that sufficient heat is supplied during a certain period of time, such that a weld of high quality is formed between the ends of the pipe 2 and the sleeve 5. Another object of the invention is therfore to offer a method that make possible in a simple, efficient and secure manner reliable temperature control and control of the heat supply to the band 6, to the weld area, such that a high-quality weld is formed.

For this reason the apparatus comprises a control and monitoring unit SR that has means CS that measure and regulate the electrical current that is supplied to the band 6, and means VS that measure and regulate the voltage U_{L} across the band 6, a thermo-element TS for the measurement of the initial ambient temperature T₀ of the weld, and a calculation unit CU for the calculation of the resistance R in the band 6 and the temperature T_{W} of the weld. In FIGS. 7-9 tree embodiments of a device A1-A3, a welding equipment, arranged at a weld area, are shown.

Once the welding process has ended, the welded joint must cool before the electrical device 8, the welding equipment, and the pressure device 9, the tension arrangement, can be removed, in order to avoid damage to the newly welded joint. The cooling period is a time-consuming part of the welding. In the context of production, it is important to achieve a high efficiency, and it is desirable to carry out the welding with a high weld quality and in a time-efficient manner. Another object of the invention is to offer a method and an apparatus that make possible efficient and reliable temperature monitoring of the cooling process in the welded joint once the welding process has ended.

For this reason the apparatus comprises an indicator unit 11 that comprises a signal output 11a that is connected to the electrically conducting band 6 in order to supply a current pulse Ip to the band 6, at least one signal input 11b connected to the electrically conducting band 6 in order to receive a signal concerning a resulting temperature-dependent parameter Sp, a CPU circuit 11c for the evaluation of the resulting temperature-dependent parameter Sp, and a signal arrangement 11d. See FIG. 10.

1. A method for joining or repairing a pipe system that comprises a least two pipes made of weldable plastic material comprising:
fitting a sleeve made of weldable plastic material the distance between the two pipes, the sleeve having a length A that exceeds the distance B between the mutually opposing pipes, such as to overlap each pipe end to a given extent C,
placing an electrically conductive band around one of the pipes, the band having two ends,
connecting the band ends to each other by placing the band ends overlapping each other,
connecting at least two conductors to the band making it possible to attach the band to an electrical device applying the electric current to the band,
placing the at least two conductors at fixed decided places around the band for even distribution of the electric current around the band and the heat around the pipe and sleeve,
fitting the sleeve over and against the pipe and the band, and
applying an electric current to the band over a given period of time,
thereby heating the band to a determined temperature for a determined time and fusing the band with the plastic surfaces of the pipe and the sleeve lying in abutment therewith to form a welding joint being fully executed around the pipe and inside the sleeve.

2. (canceled)

3. The method according to claim 2 where connecting the at least two conductors to the band comprises connecting at least two metal sheets to the band.

4. The method according to claim 1 where connecting the at least two conductors to the band comprises connecting at least one extra band between the band and each conductor, each metal sheet.

5. The method according to claim 1 where connecting the at least two conductors to the band comprises connecting at least one insulating device between the band and each conductor, each metal sheet.

6. (canceled)

7. The method according to claim 5 comprising connecting of two conductors to the band and placing the conductors at about 180° displacement in relation to each other along the band.

8. The method according to claim 1 comprising connecting of two conductors to the band and placing the conductors at about 90° displacement in relation to an electrical device, applying the electric current to the band, along the band.

9. The method according to claim 1 where the fitting of the sleeve over, around and against the pipe comprises heating the sleeve being a shrink sleeve.

10. The method according to claim 1 where the fitting of the sleeve over, around and against the pipe comprises attaching a pressure force on to and around the sleeve at the part of the sleeve fitted over, around and against the pipe.

11. The method according to claim 10 where the attaching of a pressure force on to and around the sleeve is made possible by using a pressure tool working on and around the sleeve.

12. The method according to claim 11 where the using of a pressure tool comprises using of a clamping strap which is looped around the sleeve and connecting the free ends of the clamping strap to a tensioning device which functions to tighten the loop of the clamping strap and therewith press the sleeve against the pipe.

13. The method according to claim 1 comprising drilling a hole through the sleeve for the purpose of pressure testing the made weld.

14. The method according to claim 1 comprising employing a power converter which has a quasi-resonant converter to produce the electric current that is to be connected to the band.

15. The method according to claim 1 comprising employing two series-connected power converters that are connected to two different phase and summing the output voltage via the synchronous operation of two quasi-resonant converters in order to produce the electric current that is to be connected to the band.

16. The method according to claim 1 comprising
measuring the initial ambient temperature T₀ of the weld before the band is heated,
measuring a voltage U_{L} across the band,
measuring the electrical current I_{L} supplied to the band,
calculating the initial resistance R₀ of the band before the band is heated,
supplying the electrical current to the band 6 in an altering or constant way,
calculating continuously the resistance R of the band based on the voltage and the measured current,
calculating the change ΔR in resistance,
calculating the increase ΔT in temperature of the band based on the change in resistance and calculating the temperature T_{W} of the weld through adding the initial ambient temperature T₀ of the weld and the increase ΔT in temperature of the band.

17. The method according to claim 1 further comprising:
carrying out a measurement process after the welding process has ended that comprises the supply of a current Ip to the band from an indicator unit,
determining a resulting temperature-dependent parameter Sp of the band by the indicator unit, the value of Sp is stored in the indicator unit,
supplying a further current pulse Ip is supplied to the band from the indicator unit after a predetermined time interval, that the parameter Sp in the band is determined and that the value of Sp is stored in the indicator unit,
monitoring and evaluating by the indicator unit the value of the parameter Sp or the relative change in the value of the parameter Sp,
repeating the measurement process until Sp reaches a plateau value or the relative change of Sp reaches a predetermined level,
signalling the end of the welding process by using a signal arrangement when the indicator unit indicates that the cooling process has ended and removing the welding equipment from the working area of the weld.

18. The method according to claim 1, wherein the pipe system is a thermally insulated pipe system comprising a weldable plastic outer pipe which surrounds an inner pipe embedded in an insulating layer, wherein the inner pipe lies generally exposed or is laid bare between two mutually opposing outer pipe-ends, wherein the method comprises fitting a sleeve of weldable plastic material over the exposed part of the inner pipe.

19. An apparatus to be used when using the method in claim 1 when fitting the sleeve over and against the pipe and the band, overlapping the pipe and covering the band, and applying the electric current to the band, comprising:
an electric device, applying an electric current to the band and thereby heating the band, and
a pressure tool, attaching a pressure force on to and around the sleeve at the part of the sleeve fitted over, around and against the pipe.

20. The apparatus according to claim 19 where the electric device comprises at least two electric cables each having an attaching device to be connected to the band.

21. The apparatus according to claim 20 where each attaching device is designed to be in working condition with a conductor connected to the band.

22. The apparatus according to claim 21 where the pressure tool comprises a clamping strap which is looped around the sleeve and which has two free ends and a tensioning device to which the ends of the clamping strap are connected to and which functions to tighten the loop and therewith press the sleeve against the pipe.

23. The apparatus according to claim 19 further comprising a support device to help the apparatus to be placed on the outside of the sleeve when the pressure tool is attached to the sleeve.

24. The apparatus according to claim 23 where the support device comprises guide rollers arranged in mutually parallel and mutually spaced relationship adjacent the support device.

25. The apparatus according to claim 23 where the support device comprises an abutment surface which is concave so as to provide good abutment with the outwardly curved sleeve and in that at least the abutment surface is made of an electrically insulating material.

26. The apparatus according to claim 19 comprising a power converter which has a quasi-resonant converter for producing the electric current that is to be connected to the band for a determined period of time, to heat the band and the surrounding polymer material so that they fuse together around the band in order to form a weld joint.

27. The apparatus according to claim 19 comprising two series-connected power converters that are connected to two different phases and two quasi-resonant converters that, via synchronous operation, sum the output voltage by performing a summation function to produce the electric current that is to be connected to the band for a determined period of time, to heat the band and the surrounding polymer material so that they fuse together around the band in order to form a weld joint.

28. The apparatus according to claim 19 comprising a control and monitoring unit that has means that measure and regulate the electrical current that is supplied to the band, and means that measure and regulate the voltage U_{L} across the band, a thermoelement for the measurement of the initial ambient temperature T₀ of the weld, and a calculation unit for the calculation of the resistance R in the band and the temperature T_{W} of the weld.

29. The apparatus according to claim 19 further comprising an indicator unit that comprises a signal output that is connected to the band in order to supply a current pulse Ip to the band, at least one signal input connected to the band in order to receive a signal concerning a resulting temperature-dependent parameter Sp, a CPU circuit for the evaluation of the resulting temperature-dependent parameter Sp, and a signal arrangement.
